(19) United States
(12) Patent Application Publication
(10) Pub. No.: US 2026/0105372 A1
(43) Pub. Date: Apr. 16, 2026

(54) Multi-Model, Multimodal Systems and Methods for Generating Artificial Specific Intelligence

(71) Applicant: LENS Operating Company LLC, Malibu, CA (US)

(72) Inventors: Kevin Pomplun, Malibu, CA (US); Clifford Wong, Burbank, CA (US); Joseph Hager, Burbank, CA (US); Rok Sosic, Palo Alto, CA (US)

(21) Appl. No.: 19/352,338

(22) Filed: Oct. 7, 2025

Related U.S. Application Data
(60) Provisional application No. 63/707,046, filed on Oct. 14, 2024.

(51) Int. Cl. G06N 20/00; G06N 5/04

(52) U.S. Cl. CPC G06N 20/00; G06N 5/04

(57) ABSTRACT

A multi-model system generates artificial specific intelligence through domain-partitioned intelligence frameworks applying integral calculus principles. The system represents intelligence domains as areas under curves partitioned into progressively narrower rectangular slices, where narrower partitions correspond to more specific intelligence with higher detection accuracy. A pipeline of interconnected models processes data through a classification model comprising five sequential sub-models including source validation, synthetic data detection, hallucination detection, deduplication, and clustering sub-models. A predictive model generates domain-specific predictions of future events including pre-accident scenarios with configurable lead times, while a reinforcement learning model provides feedback based on actual outcomes. The counterintuitive approach of narrowing focus rather than broadening scope enables superior accuracy in transportation safety applications. The framework supports plastic reconfiguration allowing dynamic resequencing and parallelization of models based on environmental conditions and performance requirements, and generalizes beyond transportation safety to domains where pre-accident detection and early intervention can prevent harm.

### CROSS REFERENCE(S) TO RELATED APPLICATIONS

This application claims the benefit and priority of U.S. Application Ser. No. 63/707,046, which was filed on Oct. 14, 2024, and is hereby incorporated by reference including all references and appendices cited therein for all purposes as if fully set forth herein.

### FIELD

This patent relates generally to systems and methods to generate artificial specific intelligence, and more particularly, to systems and methods to generate specific intelligence in particular domains.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a multi-model system for generating artificial specific intelligence through domain-partitioned intelligence frameworks.

The multi-model system also includes a pipeline of interconnected models configured to process data through progressively narrower domain partitions; a classification model configured to evaluate data through a plurality of sub-models operating in sequence, the sub-models may include: a source validation sub-model configured to determine validity of data sources within a specific domain, a synthetic hallucination detection sub-model configured to identify and remove synthetic data from validated sources, a deduplication sub-model configured to identify and consolidate duplicate data items, and a clustering sub-model configured to group deduplicated items based on calculated spatial proximity; a predictive model configured to generate predictions of future events based on classified data from the classification model, where the predictions are specific to narrowed domain partitions from the pipeline; a reinforcement learning model configured to provide feedback to the classification model and the predictive model based on actual outcomes compared to the predictions, where the system applies an integral calculus framework that represents intelligence domains as areas under a curve, with the system configured to partition the area into progressively narrower rectangles corresponding to more specific intelligence domains. Other embodiments of this aspect include corresponding computer systems, apparatus, and computer programs recorded on one or more computer storage devices, each configured to perform the actions of the methods.

Implementations may include one or more of the following features. The system where the specific domain is transportation safety, and the predictive model is configured to detect pre-accident scenarios including disabled vehicles, persons or objects in roadways, extreme speeding, or wrong-way drivers with configurable lead times before actual incidents occur. The system may include a transformation model configured to perform decoupled inference and annotation by processing AI algorithms on computationally efficient low-resolution data streams while the transformation model re-projects detection results onto high-resolution video outputs.

The pipeline is plastic and reconfigurable, enabling dynamic resequencing of models, parallelization of model execution, or selective enabling of models based on environmental conditions and performance requirements. The system may include a data model configured to gather raw data from a plurality of sensors monitoring an environment in the specific domain, the raw data including real-time data and background data. The system may include a transformation model configured to transform the raw data into standardized format data and generate vector flow representations for motion analysis when appearance-based detection becomes unreliable due to lighting conditions.

The system may include an optimization model configured to implement hot-swapping of computational resources across data sources based on measured hazard frequency and real-time performance metrics. The system may include a recommendation model configured to generate actionable recommendations based on the predictions, including dispatch instructions for emergency responders with time-to-impact calculations. The predictive model implements a temporal analysis functionality configured to provide advance warning of predicted events and enable intervention during pre-detection phases to prevent predicted outcomes from occurring.

Outputs of the system include a factor providing actionability ratings that prioritize life-threatening situations over property damage, and an expected value providing probability assessments between 0 and 1.0 for predicted outcomes. Implementations of the described techniques may include hardware, a method or process, or computer software on a computer-accessible medium.

One general aspect includes a method for generating artificial specific intelligence through domain-partitioned intelligence frameworks. The method also includes gathering raw data from a plurality of sensors monitoring an environment in a specific domain using a data model; transforming the raw data into standardized format data using a transformation model; classifying the standardized format data using a classification model that applies an integral calculus framework to partition the standardized format data into progressively narrower domain partitions, where the classification model includes a sequence of sub-models may include a source validation sub-model to determine data source validity, a synthetic hallucination detection sub-model to identify and remove synthetic data, a deduplication sub-model to consolidate duplicate data items, and a clustering sub-model to group deduplicated items based on calculated spatial proximity; generating predictions of future events based on classified data from the classification model using a predictive model, where the predictions are specific to the narrowed domain partitions; and providing feedback to the classification model and the predictive model based on actual outcomes compared to the predictions using a reinforcement learning model. Other embodiments of this aspect include corresponding computer systems, apparatus, and computer programs recorded on one or more computer storage devices, each configured to perform the actions of the methods.

Implementations may include one or more of the following features. The method where the specific domain is transportation safety, and the predictive model generates predictions including pre-accident scenarios such as disabled vehicles, persons or objects in roadways, extreme speeding, or wrong-way drivers with measurable lead times before incidents occur. The transformation model applies decoupled inference and annotation processing by running AI (Artificial Intelligence) algorithms on downscaled video streams while re-projecting detection overlays onto native high-resolution displays.

The method may include dynamically reconfiguring a pipeline by resequencing models, parallelizing execution, or selectively enabling models based on performance optimization targets and environmental conditions. The method may include generating actionable recommendations based on the predictions using a recommendation model, including time-sensitive instructions for emergency response coordination with calculated time-to-impact warnings. Implementations of the described techniques may include hardware, a method or process, or computer software on a computer-accessible medium.

One general aspect includes a method for generating artificial specific intelligence in a transportation safety domain to detect and prevent hazards. The method also includes collecting real-time data and background data from sensors monitoring a transportation environment using a data model; processing the collected data into a standardized format using a transformation model to produce processed data; analyzing the processed data using a classification model that applies an integral calculus framework to partition the transportation safety domain into narrower segments for enhanced accuracy, where the analyzing includes validating data sources, detecting synthetic data, removing hallucinations, deduplicating data, and clustering related data items to produce analyzed data; predicting potential pre-accident scenarios using a predictive model, including disabled vehicles, extreme speeding, or wrong-way drivers based on the analyzed data with configurable advance warning periods; and generating time-sensitive recommendations using a recommendation model to prevent or mitigate predicted hazards through early intervention based on the potential pre-accident scenarios. Other embodiments of this aspect include corresponding computer systems, apparatus, and computer programs recorded on one or more computer storage devices, each configured to perform the actions of the methods.

Implementations may include one or more of the following features. The method where the transformation model applies vector flow analysis to convert visual scenes into directional motion representations, enabling hazard detection through motion pattern analysis when lighting conditions prevent appearance-based classification. The method may include implementing hot-swapping of computational resources using an optimization model by dynamically reallocating processing power across data sources based on measured hazard frequency and changing environmental conditions.

Outputs include a factor for prioritizing actions based on severity and frequency, and an expected value providing probability assessments between 0 and 1.0 for predicted outcomes. The method may include implementing human validation through the reinforcement learning model with explicit confidence thresholds where predictions above 95% confidence proceed to operational use, 80-95% confidence requires external human validation, and 50-80% confidence requires internal validation. Implementations of the described techniques may include hardware, a method or process, or computer software on a computer-accessible medium.

### BRIEF DESCRIPTION OF THE DRAWINGS

FIG. 1A is a system architecture showing multi-model pipeline from devices through interconnected models to outputs.

FIG. 1B illustrates a plastic reconfiguration diagram showing dynamic model resequencing and parallelization capabilities.

FIG. 2 illustrates a method for applying integral calculus to partition intelligence domains into narrow segments.

FIG. 3 illustrates a method for processing data through five sequential classification sub-models.

FIG. 4 illustrates a method for decoupled inference processing with high-resolution annotation overlay.

FIG. 5 illustrates a method for vector flow analysis enabling hazard detection in low-light conditions.

FIGS. 6A and 6B collectively illustrate a method for pre-accident detection with configurable lead times and intervention.

FIG. 7 illustrates an integral calculus framework showing progressive domain partitioning for increased accuracy.

FIG. 8 is a computer system hardware diagram with processors, memory, storage, and network components.

### DETAILED DESCRIPTION OF EXAMPLE EMBODIMENTS

### Overview

This present disclosure outlines systems and methods for generating Artificial Specific Intelligence (ASI), a distinct approach from state-of-the-art Artificial Intelligence models reliant on Large Language Models (LLMs), which demand vast datasets surpassing the Internet's size and prioritize data volume over quality, whereas this invention introduces a variation on LLM architecture by leveraging specific mathematics and focusing on the quality of data sources pertinent to specific domains.

This framework models human intelligence as an area beneath a curve, with partitions representing intelligence segments like “movement” further divided into “sit,” “crawl,” and beyond, where narrower partitions yield more precise domain-specific intelligence akin to ASI, enhancing precision as domains approach infinitesimally thinner slices, encapsulated by the principle that the thinner the slice, the more precise the result.

Generating ASI necessitates a multi-model, multimodal system, exemplified by the classification model that accelerates learning and elevates intelligence through five sub-models: source validation to verify data sources, synthetic data detection to eliminate non-real data, hallucination detection to remove unsourced items, deduplication to clear duplicates, and clustering to group related items by spatial proximity.

The present disclosure demonstrates ASI applications in domains such as physics, where it validates experts like Newton, removes synthetic data and hallucinations, deduplicates items, and clusters related content for precise predictions, and basketball, where it curates data from top players for optimal simulations, contrasting with non-ASI systems that use unvalidated, mixed-quality data, thus reducing effectiveness. Domains can be mathematically combined, summing specific intelligences into general intelligence, similar to uniting elements in a Periodic Table of Intelligence, with a focus on transportation safety due to its universal relevance and potential to reduce the half billion injuries and 1.3 million annual deaths from accidents, positioning ASI as a critical tool to save lives.

### EXAMPLE EMBODIMENTS

In one aspect, the disclosure provides a multi-model system for generating ASI through domain-partitioned intelligence frameworks that apply an integral calculus mathematical foundation to achieve significantly higher accuracy than conventional artificial intelligence systems. System 100 is configured such that intelligence domains can be represented mathematically as areas underneath curves, where the application of integral calculus methodology defines these areas as infinite sums of infinitesimal rectangular partitions (or other polygonal shapes). The greater the number of rectangles under a single curve, the more accurate the measurement of intelligence within that domain. This mathematical framework enables the system to partition general intelligence into progressively narrower domain-specific intelligences, where each rectangle represents a specific slice or partition of intelligence within the broader domain.

The integral calculus framework directly translates to algorithmic implementations where each hazard type operates as a different slice under the integral, enabling domain-specific artificial intelligence that achieves greater than 95% accuracy in hazard recognition compared to general AI systems that achieve 74.9% accuracy in vision tasks. This counterintuitive approach of narrowing focus rather than broadening scope drives superior performance characteristics. The framework follows the well-established principle that “you must learn to crawl before you learn to walk,” where intelligence development progresses through increasingly specific domain partitions until reaching infinitesimally precise intelligences.

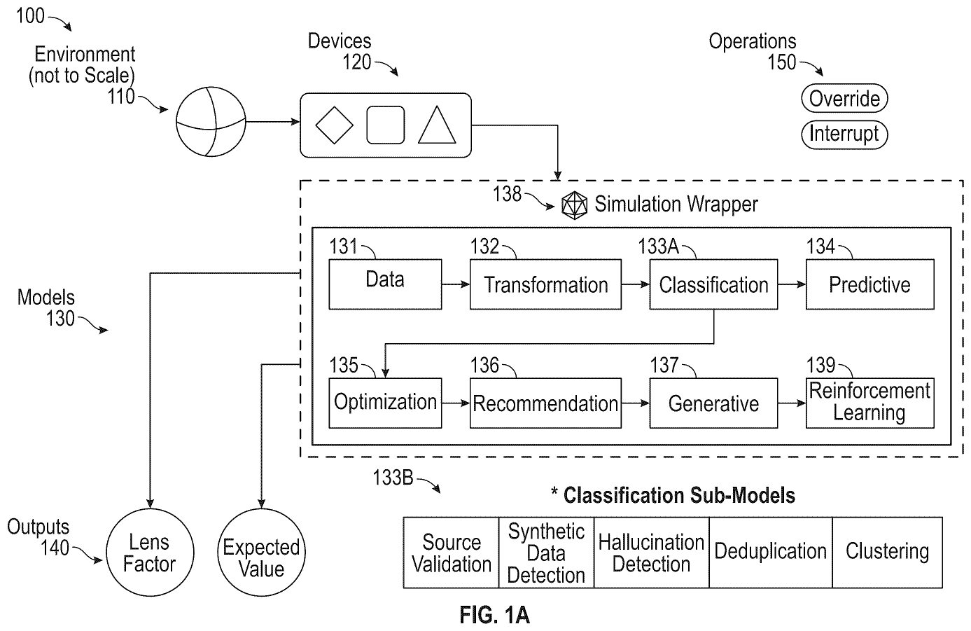

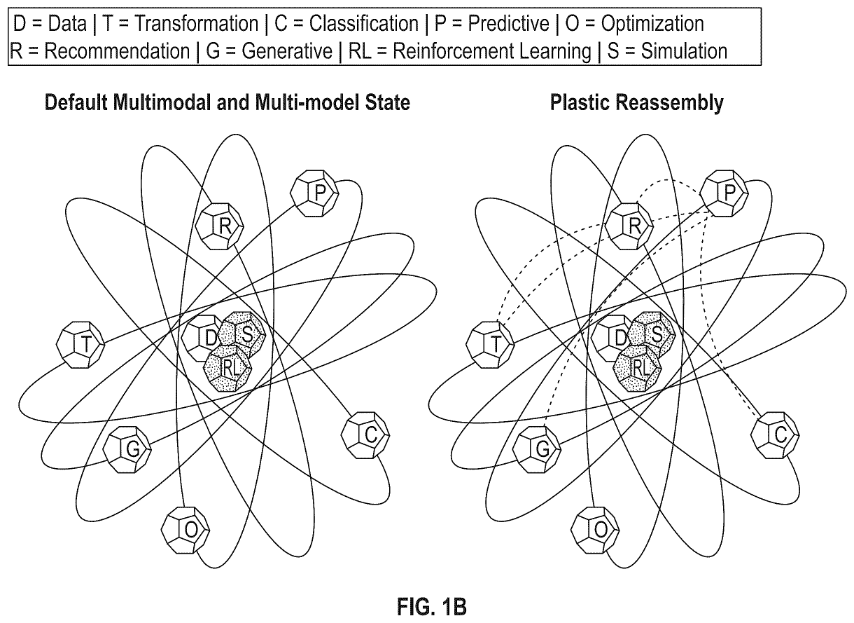

Referring now to FIG. 1, a system 100 of the present disclosure includes a pipeline of interconnected models 130 configured to process data through progressively narrower domain partitions so that general signals are successively focused into domain-specific, high-confidence intelligence. The pipeline architecture is fundamentally plastic and reconfigurable, supporting dynamic resequencing of model execution, modification of models utilized, parallelization of multiple models, and continuous learning to reorganize structure, functions, and connectivity edges. This plastic reassembly capability allows the system to adapt model sequencing and grouping based on real-time performance requirements, environmental conditions, hazard types, and computational budget constraints.

The system operates across a comprehensive organizational architecture that includes data acquisition components for gathering information from sensors, drones, cameras, and maps; perception and analytics components for sensor artificial specific intelligence processing, data quality assurance, and research and development; and platform and applications components for mobile services, web interfaces, operations interfaces, machine detection with visual effects, and data tools for accuracy evaluation. Infrastructure components provide release engineering, platform reliability monitoring, and security protections across the entire system architecture.

The pipeline includes, in at least one embodiment, a classification model 133 configured to evaluate data through a sequence of five sub-models operating in a specific order. The first sub-model is a source-validation sub-model 133B.1 that determines validity of data sources within a specific domain by identifying qualified experts in that domain, such as validating Isaac Newton, Albert Einstein, and Richard Feynman as authoritative sources for physics-related intelligence, or Michael Jordan, Magic Johnson, Bill Walton, Kobe Bryant, and LeBron James as validated sources for basketball-related intelligence. The source validation process applies algorithmic frameworks to distinguish between validated sources like agency CCTV (Closed Circuit Television) feeds versus unknown or unverified video sources, with trust ratings based on hardware specifications and industry standards.

The second sub-model is a synthetic-data detection sub-model 133B.2 that identifies and removes synthetic data from otherwise validated sources. As a defining feature of ASI, the system does not use synthetic data for training, recognizing that synthetic data introduces negative effects that reduce accuracy and intelligence quality. This approach contrasts sharply with conventional AI systems that rely heavily on synthetic training data. The synthetic data detection sub-model analyzes content from valid sources to identify any synthetic or artificially generated elements, ensuring the training corpus comprises entirely real-world data.

The third sub-model is a hallucination-detection sub-model 133B.3 that detects and removes content without attributable sourcing. This sub-model identifies and extracts hallucinations or items that were generated without any verifiable source attribution, ensuring that all data elements can be traced to legitimate origins. The hallucination detection process prevents the propagation of unsourced information that could degrade system accuracy or introduce false intelligence patterns.

The fourth sub-model is a deduplication sub-model 133B.4 that processes the resulting items and identifies and removes duplicates across temporal, spatial, and source dimensions. This sub-model prevents multiple responses to the same incident by detecting when the same event appears across multiple cameras, data sources, or time intervals. For example, when a vehicle is detected as disabled on a flooded off-ramp by multiple adjacent CCTV cameras, the deduplication sub-model identifies these as representing a single event rather than multiple separate incidents, enabling appropriate resource allocation.

The fifth sub-model is a clustering sub-model 133B.5 that groups all deduplicated items that are calculated as being near to each other based on their content being represented as points in N-dimensional space where distance calculations are possible. The clustering sub-model applies algorithms such as K-means and BFR (Bradley-Fayyad-Reina) to identify related items and group them into coherent clusters. For instance, when multiple vehicles are detected on the same flooded off-ramp but in different camera views, the clustering algorithm groups them as members of a related cluster, enabling emergency response teams to dispatch adequate resources for the complete situation rather than responding to each detection independently.

A predictive model 134 generates predictions of future events that are specific to the narrowed domain partitions produced by the classification flow. The predictive model operates on pre-accident scenarios, which are defined as detectable conditions that precede actual accidents by measurable time intervals. The system maintains a pre-accident matrix that catalogs different pre-accident types including Disabled Vehicles, Extreme Speed, Reckless Movement, Person on Highway, Wrong Way Vehicle, High Impact Collisions, Vehicle Fire, Drowning in Vehicle, and Jumping off Bridge, each with associated impact scores, feed requirements, and detection time windows.

In some instances, the clustering algorithms specifically implement K-means clustering for centroid-based grouping and BFR clustering for large-scale data processing. The K-means implementation partitions N-dimensional feature vectors into k clusters by minimizing within-cluster sum of squares, while BFR clustering handles massive datasets by maintaining summary statistics for each cluster. Distance calculations employ Euclidean distance metrics in multi-dimensional space, with cluster membership determined by proximity thresholds calibrated for each hazard type.

The predictive model 134 implements advanced temporal analysis functionality that provides configurable lead times for pre-accident detection and intervention. This temporal framework operates on the principle that narrower domain partitions enable detection of pre-incident conditions with progressively longer advance warning periods, creating temporal advantages for intervention that can prevent predicted accidents from occurring.

The system calculates intervention opportunities using velocity vectors, trajectory analysis, and environmental factors to determine optimal warning windows. For partition-specific scenarios, the predictive model 134 applies temporal calculations that extend detection windows beyond standard real-time processing: disabled vehicle scenarios provide 15-minute advance warning periods enabling proactive response deployment, wrong-way driver detection provides 30-second advance warning with trajectory calculations identifying personnel and units in potential harm, and extreme speed scenarios provide calculated time-to-impact estimates for emergency responder positioning.

The temporal analysis framework creates what can be characterized as an observer effect, where early detection and response to pre-accident conditions fundamentally alters event timelines and prevents predicted outcomes from materializing. The system's ability to identify pre-accident conditions creates intervention opportunities during the pre-detection phase where accidents exist as statistical probabilities rather than observable events, enabling prevention through early intervention rather than response after occurrence.

A reinforcement-learning model 139 provides feedback to the classification and predictive models based on measured outcomes versus predictions so that system 100 continually adjusts thresholds, routing, and model selection. The reinforcement learning implementation supports both existing third-party integrations with collaboration platforms like Slack and Teams, as well as native web service layers and plugin architectures. The system maintains baseline parameters that can be matched with models being evaluated against those baselines, implements data labeling tools for human validation, applies cross-validation logic for accuracy measurement, and links to framework references for continuous improvement.

In certain embodiments, the domain-partitioning logic is expressed as an integral-calculus framework in which an intelligence domain is represented as an area under a curve, and the system partitions that area into progressively narrower rectangles corresponding to increasingly specific intelligences. As the partitions narrow toward infinitesimal width, the system converges toward maximally specific intelligence for the target domain. This mathematical foundation enables the union of separate domain-specific intelligences to create higher-order combined intelligences, similar to how elements in the Periodic Table combine to create compounds, such as Sodium (Na) and Chloride (Cl) combining to create NaCl (salt). Domain-specific intelligences like “human-to-human”defense and “zone defense” in basketball can be combined to create “combination defense” strategies.

From a broader perspective, devices 120 in environment 110 supply both real-time and background data to a data model 131 that standardizes and tags inputs by source, trust level, and modality. The device architecture supports a comprehensive sensor ecosystem including but not limited to optical devices, cameras, live feed video cameras, traffic cameras, security cameras, surveillance cameras, car cameras, CCTV cameras, drones, robots, thermal cameras, accelerometers and gyroscopes, GPS (Global Positioning) sensors, temperature sensors, pressure sensors, motion coprocessors, microphones, heart rate monitors, vibration sensors, Bluetooth beacons, WiFi signals, proximity sensors, infrared sensors, ultrasonic sensors, radar systems, LiDAR (Light Detection and Ranging) systems, barometric pressure sensors, inertial measurement units, impact sensors, smartphone sensors, environmental sensors, tire pressure monitoring systems, dashboard cameras, traffic signal sensors, inductive loop sensors, connected vehicle systems, onboard diagnostic systems, collision avoidance systems, voltage sensors, current flow sensors, voltage regulation systems, load capacity monitors, alternating current sensors, altimeters, neutron flux density sensors, seismic activity sensors, hydrogen concentration sensors, and water conductivity sensors.

In some examples, the comprehensive sensor ecosystem encompasses voltage sensors for monitoring electrical grid stability, current flow sensors for detecting power anomalies, voltage regulation systems for maintaining infrastructure stability, load capacity monitors for preventing overload conditions, alternating current sensors for AC (Alternating Current) power monitoring, altimeters for elevation-dependent analysis, neutron flux density sensors for nuclear facility monitoring, seismic activity sensors for earthquake detection, hydrogen concentration sensors for gas leak detection, and water conductivity sensors for flood and contamination monitoring. Each sensor type contributes domain-specific intelligence that integrates through the multi-model pipeline to create comprehensive hazard awareness across transportation, utility, and environmental domains.

The data acquisition architecture operates through multiple specialized components including sensors that gather and standardize IoT (Internet of Things) data such as IoT sensors mounted on utility poles that provide precise degree orientations for structural monitoring, drones that gather comprehensive video and sensor data with LENS ASI-Drone units capable of scanning two square miles of utility poles for infrastructure assessment, cameras that gather video data including LENS Detect processing of approximately 2,886 Caltrans cameras across the California highway system, and maps components that gather geographic and infrastructure data including LENS crawlers that gather gas pipeline data for future flight planning and route optimization. Fewer or more infrastructure elements can be included that those given in examples.

Each data source receives both an internal LENS ID optimized for machine operations that is unique to the platform, and an external ID optimized for human operations. The external ID format combines Agency Division, camera number ID, and unique location identifiers to handle scenarios where multiple cameras share the same number across different divisions. For example, Division 514 camera ID 117 located on the I-10 exit for Crenshaw Boulevard would receive the external ID “D514-117-110-Crenshaw,” providing human-readable identification while maintaining uniqueness across the platform.

The system implements a comprehensive data hierarchy ranging from real-time data to background data, with hierarchy determinations based on predefined trust ratings grounded in hardware specifications and industry standards. Real-time data from validated sources receives the heaviest weighting, while background data provides contextual information including historical accident records, demographics, traffic patterns, socioeconomic factors, news information, weather data, and domain-specific contextual information. The data hierarchy impacts processing priority, with high-volume real-time data from trusted sources processed immediately while lower-priority background data provides training and contextual enhancement for the models.

A transformation model 132 converts heterogeneous inputs into standardized formats for downstream processing, which may include normalization procedures, feature extraction algorithms, optical-flow vectorization for motion analysis, resizing operations, and other modality-specific transforms. The transformation model handles the inherent variability and noise in raw sensor data by applying standardization procedures that create consistent, uniform formatting suitable for downstream artificial intelligence processing. In low-light scenarios, the transformation model generates vector-flow representations that convert visual scenes into directional motion fields, enabling detection based on movement patterns when appearance-based classification becomes unreliable due to lighting conditions

The transformation model implements sophisticated preprocessing capabilities including region-of-interest processing that focuses computational attention on relevant areas for hazard detection. Scene-specific image enhancement algorithms calibrate processing based on lighting conditions, weather factors, and environmental variables. Stabilization algorithms suppress flicker and eliminate common false positives caused by camera vibration from wind, lens smudging, obstruction from spider webs or debris, and other environmental interference factors. Motion-difference analysis between consecutive frames identifies legitimate changes while filtering out noise and environmental artifacts.

A classification model 133, including the sequence of sub-models described above, performs comprehensive source vetting, synthetic content screening, hallucination removal, deduplication across time and sources, and spatial clustering to form coherent events. The classification model routes processed data to hazard-specific detection algorithms, each optimized for particular types of events or conditions. For visual processing, the system uses SSD MobileNet™ as a baseline architecture, with provisions for evaluating alternative models such as YOLO (You Only Look Once) when accuracy requirements exceed baseline performance for specific hazards and environmental conditions.

The perception and analytics architecture includes sensor ASI components that accurately interpret data to create actionable intelligence through computer vision and machine learning frameworks, achieving hazard recognition accuracy greater than 95% in operational deployments. Data quality components ensure sources and produced data maintain high quality through performance tools and analysis of vision AI accuracy, implementing automated and manual testing for continuous model performance gains. Research and development components explore ideas outside existing operations, such as designing prototypes of extreme weather durable drones for enhanced environmental resilience.

For field-of-view requirements, the system enforces minimum scene visibility duration, requiring that vehicles remain visible within camera scenes for at least three seconds to ensure reliable detection and tracking. Cameras with insufficient field-of-view coverage, such as license plate readers with extreme close-up perspectives, are excluded from hazard detection processing due to inadequate scene coverage for safety-relevant analysis. As used here, ‘field of view’ is the angular extent imaged by the module, expressed as horizontal, vertical, and diagonal FOV.

A predictive model 134 produces outcome forecasts tied to each clustered event, including probability estimates, timing predictions, and trajectory analysis for pre-accident scenarios. The predictive model specializes in extreme speed detection, generating time-to-impact calculations and trajectory predictions for vehicles exceeding configurable speed thresholds. For California Highway Patrol deployments, extreme speed is configured as 100+ mph on highways, while county and municipal deployments use relative extreme speed thresholds appropriate for local road conditions and traffic patterns.

The predictive model implements sophisticated pre-accident detection algorithms that analyze confidence values from AI inferencing combined with traffic flow analysis. For person-on-roadway scenarios, the system first detects human presence with specified confidence thresholds, applies processing to confirm roadway location, validates detection through AI inferencing, and then analyzes movement patterns relative to traffic flow. If detected movement aligns with traffic flow direction and speed, the system classifies the detection as a likely false positive. If movement patterns diverge from normal traffic flow, the system generates a high-priority pre-accident alert indicating imminent safety risk.

An optimization model 135 tunes thresholds, sampling rates, model selection, and compute placement to satisfy accuracy and latency objectives within operational budgets. The optimization model performs real-time resource allocation, implementing hot-swapping capabilities that dynamically reallocate computing resources across camera feeds based on changing conditions such as traffic density, lighting changes, or measured hazard frequency. This capability enables the system to maintain consistent performance while optimizing resource utilization across large-scale deployments.

A recommendation model 136 turns forecasts into concrete, domain-appropriate actions and generates specific recommendations including dispatch instructions, lane closure procedures, signage modifications, emergency notifications, and inter-agency coordination messages. The recommendation model considers the full context of predicted events, available response resources, traffic conditions, and agency protocols to generate actionable intelligence that responders can implement immediately.

A generative model 137 can fabricate domain-specific scenarios for training, simulation, and what-if analysis, including rare edge-case events that might not appear frequently in real-world training data. The generative model creates synthetic scenarios for testing and validation while maintaining the core principle that actual training data consists exclusively of real-world examples. Generated scenarios support simulation and planning exercises without compromising the integrity of the primary training corpus.

A simulation model 138 projects predicted futures and counterfactual outcomes under alternative interventions so that the system can rank actions by expected impact. The simulation model enables analysis of different response strategies, resource allocation scenarios, and intervention timing options to optimize safety outcomes and resource efficiency.

A reinforcement-learning model 139 integrates human or automated feedback about which recommendations were acted upon and which predictions were borne out, closing the loop to improve subsequent classification, prediction, and recommendation accuracy. The reinforcement learning implementation includes human-in-the-loop validation workflows where detected events are presented to operators for thumbs-up, thumbs-down, or unknown classifications. These validation responses are automatically routed into verified, inaccurate, or unknown queues that drive accuracy measurements, promotion thresholds, and model retraining processes.

The platform and applications architecture includes data tools that provide internal and external data quality evaluation capabilities, building and evolving data feedback interfaces such as web labeling tools that enable rating the accuracy of LENS hazard detection. Mobile services provide users with mobile applications to access LENS data simply and efficiently, building and evolving mobile app integrations including LENS Detect posts in Microsoft Teams for utility customers. Web components provide users with web applications that are simple and memorable, building and evolving web applications such as LENS Dash interfaces for highway patrol agencies to view camera mosaics and CCTV lists.

Operations interfaces provide device operators with intuitive controls, building and evolving control interfaces for devices including LENS ASI-Drone control interfaces that integrate both hardware and software components. Machine detection components build and evolve VFX (Visual Effects) animations and visual effects that enable users to see what LENS ASI systems detect, including LENS Detect ASI-Drone scans of utility poles with simulated fall trajectories for predictive analysis.

System 100 produces outputs 140 that, in various embodiments, include a LENSfactor for ranking potential actions and an expected-value metric that provides probabilities between 0 and 1.0 for predicted outcomes. The LENSfactor prioritization metric reflects both severity and frequency characteristics, with prioritization order typically addressing life-threatening situations first, followed by non-life-threatening injuries, and finally property-damage-only events. The LENSfactor describes the actionability of resulting intelligence, where higher values indicate situations requiring immediate physical response and intervention.

The expected value output represents the probability that a detected process, object, or spatial condition will result in the predicted outcome under current environmental and traffic conditions. Expected values range from 0 to 1.0, with values approaching 1.0 indicating near-certainty of the predicted outcome. The system calculates expected values using confidence levels from AI inferencing combined with environmental factors, historical pattern analysis, and real-time contextual information.

The architecture is plastic in that the orchestrator may resequence models 130, parallelize subgraphs, or omit nonessential stages for a given deployment, scene, or performance budget. This plasticity enables the system to adapt to varying computational resources, environmental conditions, and operational requirements while maintaining core safety and accuracy objectives. Plasticity also permits domain-specific attention mechanisms that can dynamically adjust processing focus based on environmental conditions such as lighting changes, weather events, or temporary obstructions.

The system implements decoupled inferencing and annotation capabilities that represent a significant technical innovation for managing computational efficiency while maintaining high-resolution output quality. In this approach, AI inferencing operates on computationally efficient downscaled video streams while annotations and detection overlays are re-projected onto native high-resolution video outputs. This creates an optical illusion where operators perceive high-resolution AI processing while the underlying computational load operates on lower-resolution data, dramatically reducing GPU (Graphics Processing Unit) requirements while preserving visual clarity for human operators.

For nighttime or low-visibility conditions, the system implements vector flow analysis that converts visual scenes into directional motion representations. This approach enables wrong-way vehicle detection through motion pattern inversion analysis even when lighting conditions prevent reliable appearance-based object classification. Vector flow analysis identifies movement patterns that contradict normal directional traffic flow, triggering high-priority alerts and enabling rapid response to wrong-way driving incidents regardless of visibility limitations.

The infrastructure architecture includes release engineering components that ensure release quality as final gatekeepers, managing the releasing of hardware and software updates including new VFX animations for LENS Detect drone scans. Platform reliability components maintain stability and performance of the platform through monitoring, alerts, and incident management, such as detecting when a LENS Dash interface becomes unavailable and pushing corrective fixes. Security components proactively prevent system attacks through vulnerability and risk analysis, testing, and shadow testing capabilities, including detecting and stopping potential server compromises before they can affect operations.

Because domain partitions narrow progressively through the integral calculus framework, the same pipeline architecture generalizes beyond any single vertical application while still allowing highly tuned, domain-specific behavior where precision and accuracy matter most. The mathematical foundation supports applications across transportation safety, utility infrastructure monitoring, wildfire prevention, and other domains where pre-accident detection and early intervention can prevent harm and save lives.

Human validation remains a fundamental requirement across all system operations, with all models requiring human validation by default. Client agencies such as the California Highway Patrol can disable human validation if desired, but the system operates with validation enabled by default. The platform provides comprehensive accuracy dashboards that are available and transparent to all stakeholders, enabling continuous monitoring of system performance and reliability.

The system implements explicit accuracy confidence thresholds that govern operational promotion decisions. Detections achieving 95% or higher confidence levels qualify for direct operational use and proceed straight to LENS Feed systems. Items achieving 80% or higher confidence require officer human external validation through interfaces such as CHP validation dashboards. Detections with 50% or higher confidence require human internal validation through LENS team validation dashboards. Items with 49% or lower confidence remain in development phases under LENS model performance engineering oversight. This graduated validation approach ensures that human operator time is allocated efficiently and that partners receive only data worth validating, maximizing the value of human expertise while maintaining safety and reliability standards.

The foregoing broad description applies to many domains, with transportation safety providing a representative implementation that aligns with FIGS. 1A and 1B and demonstrates the practical application of the integral calculus framework to real-world safety challenges. In transportation embodiments, devices 120 include validated agency CCTV cameras and sensor networks positioned strategically along roadways, intersections, ramps, and other critical infrastructure locations.

The data model ingests live video streams along with contextual background information including historic incident records, roadway geometry data, traffic pattern analysis, and environmental conditions. A pre-training and evaluation workflow crawls Computer-Aided Dispatch (CAD) incident logs, geolocates reported incidents, and triangulates them against camera viewshed coverage areas. Incidents occurring within camera view are used for benchmarking and system evaluation, while incidents outside camera coverage are labeled as undetected to maintain honest accuracy assessment.

The transformation model prepares video frames and ancillary sensor signals for downstream processing, optionally generating vector-flow fields in low-light conditions to retain directional movement information when appearance-based detection becomes unreliable. Processing algorithms configure attention regions specifically for different roadway types including highways, on-ramps, off-ramps, tunnels, and intersection approaches, with boundary adjustments based on lane configurations, shoulder areas, and traffic flow patterns.

The classification sequence first validates video feed sources using established trust criteria, removes any synthetic or non-attributable content to ensure training data integrity, deduplicates detections across adjacent video frames and neighboring camera coverage areas, and clusters spatial observations to form single coherent events. For example, a stalled vehicle detected by multiple cameras along a roadway segment would be consolidated into a single incident requiring response rather than generating multiple separate alerts.

The predictive model estimates near-term outcomes for various pre-accident scenarios including time-to-impact calculations for extreme-speed trajectory analysis, escalation likelihood assessments for stopped vehicles in active traffic lanes, and collision probability estimates based on traffic density and environmental conditions. Pre-accident lead times are configurable based on hazard type, with disabled vehicles typically providing 15-minute lead times while extreme speed events may provide only 30-second advance warning based on detection capabilities and intervention requirements.

The recommendation model converts predictive forecasts into specific actionable responses including emergency dispatch instructions, dynamic signage modifications, lane closure procedures, traffic rerouting recommendations, and inter-agency notification protocols. Recommendations account for available response resources, current traffic conditions, weather factors, and established emergency response procedures to ensure practical implementability.

Where camera resolution or bandwidth constraints limit processing capabilities, the orchestrator applies decoupled inference and annotation processing, running computationally intensive AI algorithms on downscaled video streams while re-projecting detection results and annotation overlays onto native high-resolution video displays. This approach enables operators to maintain visual clarity and situational awareness while managing computational costs within available GPU and processing budgets.

In wrong-way vehicle scenarios occurring during nighttime hours, vector-flow inversion analysis reveals motion patterns that contradict normal directional traffic flow even when headlight glare or insufficient lighting obscures traditional object classification approaches. The system identifies reversed motion vectors relative to expected traffic flow patterns, enabling high-priority alert generation, cross-agency notification propagation, and immediate countermeasure initiation regardless of visibility limitations.

Throughout operational deployment, reinforcement learning processes utilize human validation signals and measured outcome accuracy to recalibrate detection thresholds, reweight data source trust levels, and promote or demote model subgraphs based on performance metrics. This continuous improvement cycle enhances both accuracy and response time over successive operational cycles while maintaining the fundamental integrity of the domain-specific intelligence framework.

The system maintains comprehensive accuracy tracking through rolling performance reports, explicit promotion threshold management, and automated retraining gate controls based on measured performance against established baselines. Training and evaluation processes follow systematic frameworks where objectives and success metrics are defined per hazard type, real-world datasets are assembled from validated sources, detection algorithms are benchmarked against stable baselines, and promotions are gated by demonstrated performance improvements.

All detection events are stored with comprehensive metadata in a centralized repository enabling longitudinal accuracy analysis, configuration transfer between deployment sites, and proportional compute allocation to data sources demonstrating highest measured hazard frequency. This approach ensures operational impact improves continuously across the network while maintaining cost-effectiveness and resource optimization.

In practice, FIG. 1A depicts the logical pipeline progression from data ingestion through model processing to recommendation generation and reinforcement learning feedback, while FIG. 1B depicts the multi-model, multimodal assembly architecture and its plastic reconfiguration capabilities for transportation safety and other domain applications. FIG. 1B illustrates the default processing flow through the domain-partitioned framework, while the right side illustrates dynamic reassembly paths where models 130 can be reordered, parallelized, or selectively enabled according to domain requirements, environmental conditions, scene characteristics, and performance optimization targets.

The same architectural principles can be applied across diverse domains beyond transportation safety. Utility infrastructure applications can detect power lines or utility poles with abnormal orientations that may fail during severe weather events, analyze vegetation growth patterns that pose risks to electrical infrastructure, and predict equipment failure modes based on environmental stressors and historical performance data. The system's ability to scan two square miles of utility poles through ASI-Drone technology enables comprehensive infrastructure monitoring at scale previously impossible with manual inspection methods.

Wildfire prevention applications can monitor vegetation moisture levels, analyze wind patterns and weather conditions, detect early ignition sources, and predict fire spread patterns to enable proactive intervention before emergency conditions develop. Environmental monitoring applications can track air quality changes, water contamination events, seismic activity patterns, and other environmental hazards that pose risks to public safety.

By introducing the fundamental structures of progressive domain partitioning based on integral calculus principles, the specific sequence of classification sub-models with their ordered processing requirements, predictive modeling with reinforcement learning feedback loops, and prioritized probabilistic output generation, the system architecture supports broad applicability across domains while preserving concrete, field-tested implementations that have demonstrated operational effectiveness in transportation safety deployments spanning approximately 2,886 camera installations.

The mathematical foundation ensures that intelligence generation becomes increasingly precise as domain partitions narrow, enabling artificial specific intelligence to achieve demonstrably superior accuracy exceeding 95% compared to general artificial intelligence approaches while maintaining the flexibility to address diverse safety-critical applications where early intervention can prevent accidents and save lives through comprehensive human validation frameworks that prioritize human expertise while maximizing operational efficiency.

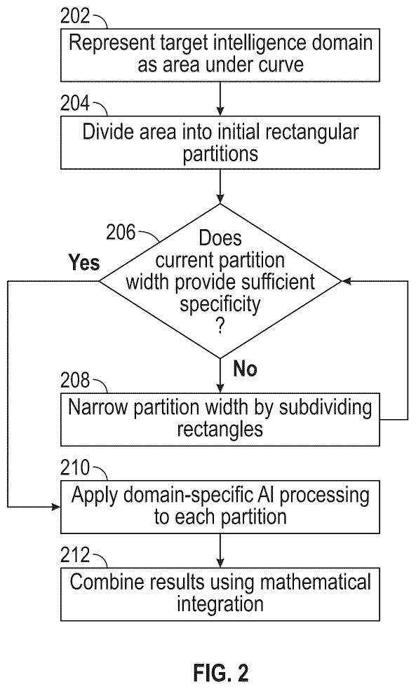

FIG. 2 illustrates the method for applying integral calculus principles to partition intelligence domains into progressively narrower segments for enhanced accuracy. The method begins at step 202 by representing the target intelligence domain as an area under a curve, following the mathematical principle that the greater the number of rectangles under a single curve, the more accurate the measurement of intelligence within that domain.

At step 204, the system divides this area into initial rectangular partitions, where each rectangle represents a specific slice of intelligence within the broader domain, such as partitioning “movement” intelligence into narrower rectangles of “sit,” “crawl,” “walk,” “run,” and “sprint,” which can be further subdivided into even more specific intelligences like “balance to crawl,” “core control to crawl,” and “coordination to crawl.” Decision step 206 evaluates whether the current partition width provides sufficient specificity for the target accuracy requirements by comparing current performance metrics against established baselines.

If the partition width remains too broad, the method proceeds to step 208 to narrow the partition width by subdividing existing rectangles into smaller, more specific domain segments. This narrowing process enables the counterintuitive approach where increased specificity leads to higher accuracy rather than broader generalization. The method continues this iterative narrowing process until decision step 206 determines that partition width has approached infinitesimal dimensions for maximum precision. At step 210, the system applies domain-specific artificial intelligence processing to each narrowed partition using hazard-specific algorithms optimized for the particular intelligence slice. The method concludes at step 212 by combining the results from all partitions using mathematical integration principles to generate the final domain-specific intelligence output with demonstrably superior accuracy compared to general AI approaches.

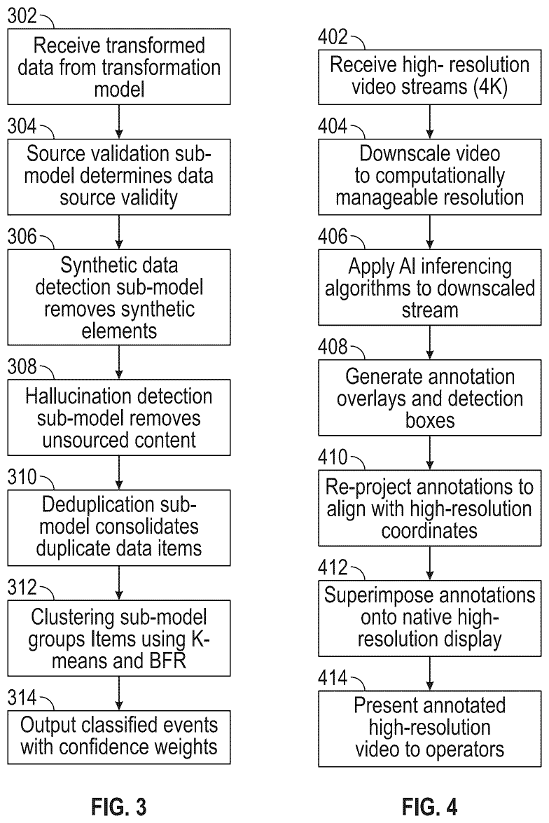

FIG. 3 depicts the method for processing data through the classification model's five sequential sub-models to ensure data quality and reliability. The method begins at step 302 by receiving transformed data from the transformation model that has been standardized and normalized for downstream processing. At step 304, the source validation sub-model determines validity of data sources within the specific domain by identifying qualified experts such as Isaac Newton, Albert Einstein, and Richard Feynman for physics domains, or Michael Jordan, Magic Johnson, and Lebron James for basketball domains, while applying trust ratings based on hardware specifications and industry standards to distinguish validated agency CCTV feeds from unverified sources.

The method proceeds to step 306 where the synthetic data detection sub-model analyzes content using algorithms trained on continuously updating directories of real and synthetic data to identify and remove any synthetic or artificially generated elements, ensuring the training corpus comprises entirely real-world data as a defining feature of ASI. At step 308, the hallucination detection sub-model detects and removes content without attributable sourcing by comparing against directories of historical hallucinations produced by other systems, preventing the propagation of unsourced information that could degrade system accuracy.

Step 310 applies the deduplication sub-model to identify and consolidate duplicate data items across temporal, spatial, and source dimensions, preventing multiple responses to the same incident by detecting when events appear across multiple cameras or time intervals, such as identifying a disabled vehicle detected by multiple adjacent cameras as a single incident. At step 312, the clustering sub-model groups all deduplicated items using algorithms such as K-means and BFR to calculate proximity in N-dimensional space, clustering related items like multiple vehicles on the same flooded off-ramp into coherent groups for appropriate resource allocation. The method concludes at step 314 by outputting classified events and objects of interest with associated confidence weights for downstream predictive processing.

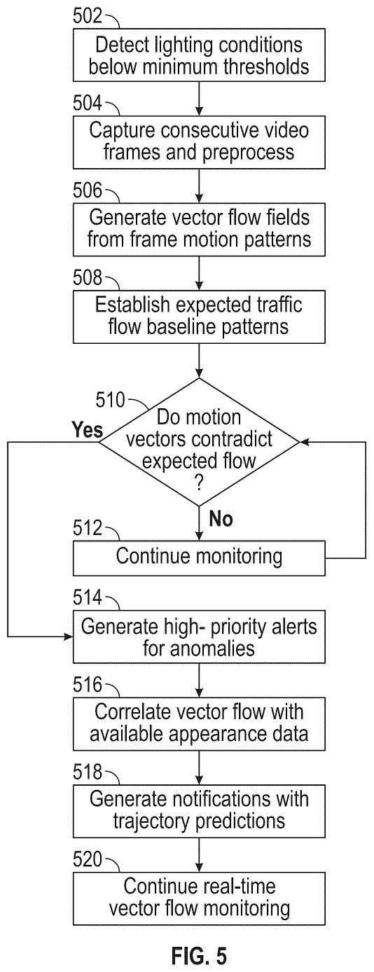

FIG. 4 illustrates the method for performing computationally efficient AI processing while maintaining high-resolution visual output quality through decoupled inference and annotation. The method begins at step 402 by receiving high-resolution video streams from camera sources, typically 4K resolution feeds that would normally require prohibitive computational resources for real-time AI processing.

At step 404, the system downscales the high-resolution video to a computationally manageable resolution suitable for AI inferencing while preserving essential visual features needed for hazard detection. Step 406 applies AI inferencing algorithms, such as SSD MobileNet or YOLO models, to the downscaled video stream to identify potential hazards, objects, or events of interest with appropriate confidence thresholds. At step 408, the system generates annotation overlays, detection boxes, and visual indicators based on the inferencing results, including hazard classifications, confidence scores, and recommended actions.

Step 410 performs the critical re-projection process where the annotations generated from the low-resolution inferencing are mathematically scaled and positioned to align with the corresponding locations in the original high-resolution video stream. This re-projection process accounts for scaling factors, aspect ratio differences, and coordinate transformations to ensure pixel-accurate overlay placement. At step 412, the system superimposes the re-projected annotations onto the native high-resolution video display, creating an optical illusion where operators perceive high-resolution AI processing capabilities while the underlying computational load operates on significantly lower resolution data. The method concludes at step 414 by presenting the annotated high-resolution video to human operators with detection overlays that provide clear visual clarity for situational awareness while maintaining computational efficiency that enables large-scale deployment across thousands of camera feeds.

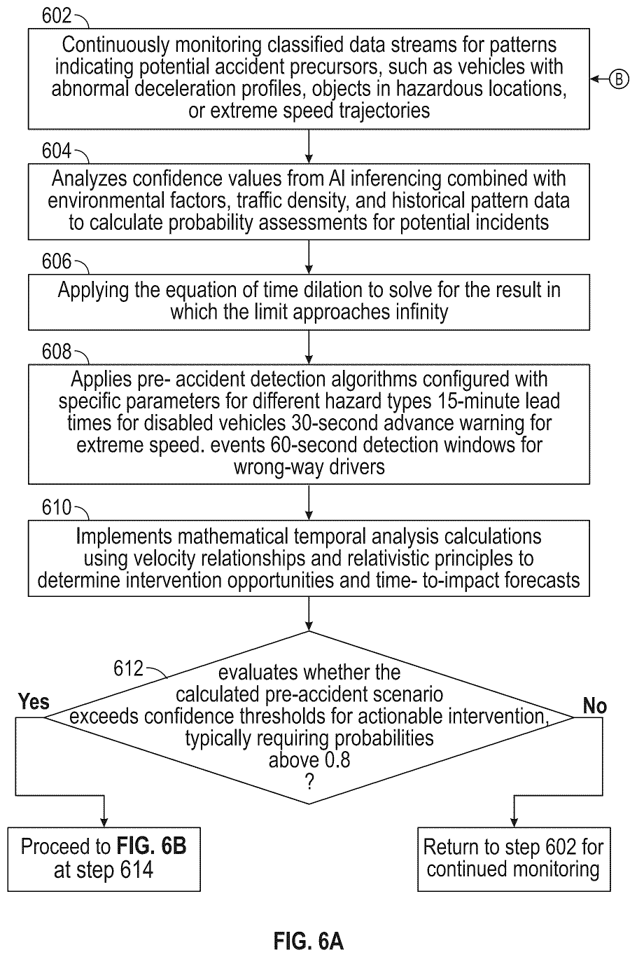

FIG. 5 depicts the method for converting visual scenes into directional motion representations to enable hazard detection when lighting conditions prevent reliable appearance-based classification. The method begins at step 502 by detecting environmental conditions where lighting levels fall below minimum thresholds required for traditional object recognition, such as nighttime scenarios, fog conditions, or situations with extreme glare from headlights.

At step 504, the system captures consecutive video frames from the compromised visual feed and applies preprocessing to extract maximum available visual information despite lighting limitations. Step 506 generates vector flow fields by analyzing frame-to-frame motion patterns, creating directional arrows and velocity representations that indicate movement characteristics across the scene regardless of object appearance clarity.

At step 508, the system establishes expected traffic flow patterns for the monitored location based on historical data, road geometry, and normal traffic directions, creating a baseline vector flow model representing typical movement patterns. Decision step 510 compares detected motion vectors against the expected traffic flow baseline to identify anomalies or inversions that indicate potential hazards. If motion patterns align with expected flow, the method proceeds to step 512 for continued monitoring. If motion vectors show inversion or contradiction to normal flow patterns, the method advances to step 514 to generate high-priority alerts for potential wrong-way drivers or other directional hazards.

At step 516, the system correlates vector flow anomalies with any available appearance-based detection results when lighting conditions permit partial object recognition, creating comprehensive hazard assessments that combine motion and appearance intelligence. Step 518 generates time-sensitive notifications to dispatchers and emergency responders with specific location data, predicted trajectory information, and recommended countermeasures based on the detected motion anomalies. The method concludes at step 520 by continuing real-time vector flow monitoring while maintaining readiness to transition back to appearance-based detection when lighting conditions improve.

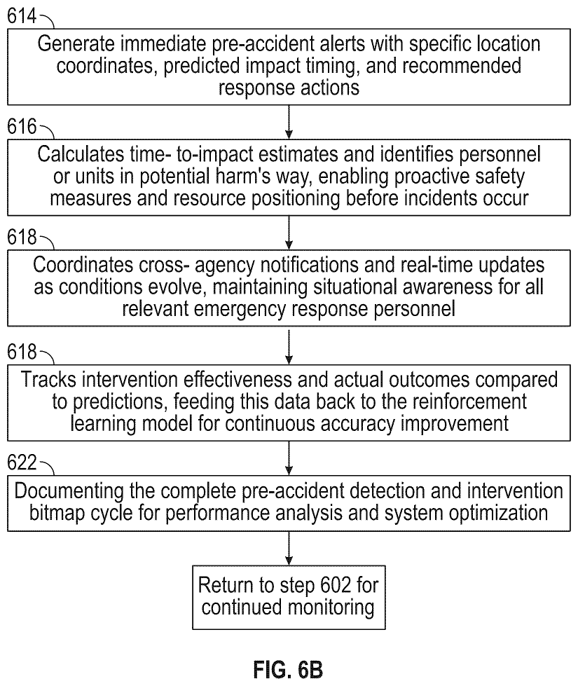

FIGS. 6A and 6B collectively illustrate the method for detecting pre-accident scenarios with configurable lead times and implementing time dilation principles to enable early intervention. In practice, the LENS Specific AI uses the equation as an optimization function to maximize lives saved. The method begins at step 602 by continuously monitoring classified data streams for patterns indicating potential accident precursors, such as vehicles with abnormal deceleration profiles, objects in hazardous locations, or extreme speed trajectories. At step 604, the system analyzes confidence values from AI inferencing combined with environmental factors, traffic density, and historical pattern data to calculate probability assessments for potential incidents.

The method includes a step 606 of applying the equation of time dilation to solve for the result in which the limit approaches infinity. When the time dilation of any pre-accident can be calculated in which the result approaches infinity, it mathematically proves the pre-accident will not become an accident. This can be seen through comparing the proofs of a pre-accident resulting in an accident, and a pre-accident in which an accident never occurs. The proof of a pre-accident resulting in an accident with a result in which the limit does not approach infinity is as follows:

Take the case in which a pre-accident is not responded to and in result an accident occurs a, for example a refrigerator that falls off a truck on a freeway late at night is not detected and several hours later a vehicle collides with that refrigerator as the driver is on the way to work. Then it follows that the accident does occur at a finite observer time: Tcrash (where the video feeds shows the accident after Tcrash seconds), set Δt=Tcrash.

$$Then : {Δτ}_{c a r} = \frac{{T}_{c r a s h}}{γ}$$

$$and because$$

$$1 \leq γ < ∞ , 0 < {τ}_{c a r} \leq {T}_{c r a s h} Δ {τ}_{c a r} < {T}_{c r a s h} if v > 0$$

When an accident (or crash) occurs at a finite observer time, the car's experienced (proper) time to the crash is finite and shorter by the factor of 1/γ as defined by time dilation. The time difference is:

$${T}_{c r a s h} - Δ {τ}_{c a r} = {T}_{c r a s h} ( 1 - \frac{1}{γ} ) > 0 for v > 0$$

Upon the system returning a result that the car's experienced (proper) time is both finite and shorter by the factor of 1/γ, it concludes that response is not adequate to keep a pre-accident from becoming an accident.

In contrast, when the system applies time dilation to solve for a result in which the limit approaches infinity, it will generate the following:

$$Time dilation : Δ t = γ Δ τ ⇒ Δ τ = \frac{Δ τ}{γ}$$

$$with γ = \frac{1}{\sqrt{1 - \frac{{v}^{2}}{{c}^{2}}}} \geq 1 for any 0 \leq v < c$$

Returning to the same setting with a slightly different environment, in which a pre-accident is responded to by the and in result an accident never occurs and is prevented, for example a refrigerator that falls off a truck on a freeway late at night is detected and shortly thereafter the California Highway Patrol removes the object in the road, the vehicle being driven on the way to work several hours later never collides with the refrigerator as it is no longer there. Then it follows that the pre-accident is removed resulting in no accident, the observer's elapsed time is an ever-increasing horizon T→∞.

$$Then Δτ ( T ) = \frac{T}{γ}$$

$$and because γ is finite for {lim}_{T \to ∞} Δ τ ( T ) = {lim}_{T \to ∞} \frac{T}{γ} = ∞ v < c ,$$

Upon the system returning a result that the car's experienced (proper) time and the observer's time T/γ diverge, there is no finite interval to the accident that never occurs. With the application of time dilation and calculation of a result where a) the car's experienced (proper) time is both finite and shorter by the factor of 1/γ indicating an accident will occur, or b) the car's experienced (proper) time and the observer's time T/γ diverge indicating an accident will never occur—the system has a framework that gives it a universal determination of any potential scenario to optimize for a limit approaching infinity, and in result optimizing for preventing the maximum number of accidents.

Step 608 applies pre-accident detection algorithms configured with specific parameters for different hazard types, including 15-minute lead times for disabled vehicles, 30-second advance warning for extreme speed events, and 60-second detection windows for wrong-way drivers. At step 610, the system implements mathematical temporal analysis calculations using velocity relationships and relativistic principles to determine intervention opportunities and time-to-impact forecasts.

Decision step 612 evaluates whether the calculated pre-accident scenario exceeds confidence thresholds for actionable intervention, typically requiring probabilities above 0.8 for emergency response activation. If thresholds are not met, the method returns to step 602 for continued monitoring.

If intervention thresholds are exceeded, the method proceeds to step 614 to generate immediate pre-accident alerts with specific location coordinates, predicted impact timing, and recommended response actions. Step 616 calculates time-to-impact estimates and identifies personnel or units in potential harm's way, enabling proactive safety measures and resource positioning before incidents occur. At step 618, the system coordinates cross-agency notifications and real-time updates as conditions evolve, maintaining situational awareness for all relevant emergency response personnel.

Step 618 tracks intervention effectiveness and actual outcomes compared to predictions, feeding this data back to the reinforcement learning model for continuous accuracy improvement. The method concludes at step 622 by documenting the complete pre-accident detection and intervention cycle for performance analysis and system optimization.

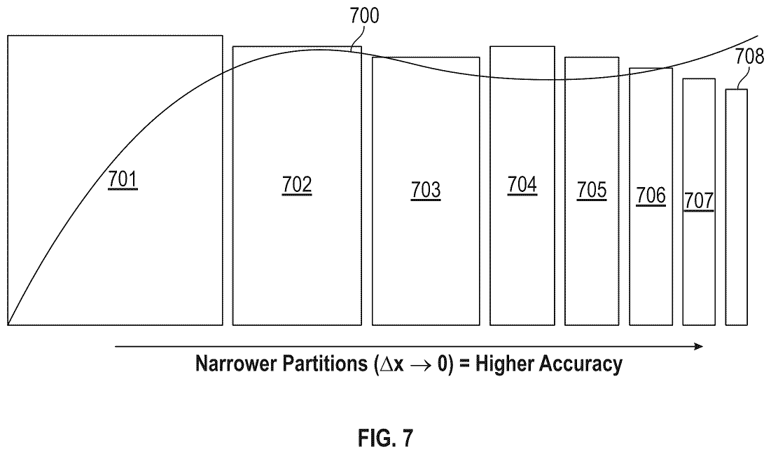

FIG. 7 illustrates the integral calculus framework that underpins the artificial specific-intelligence architecture in FIG. 1A. The system implements progressive domain partitioning so that narrower intelligence slices yield higher accuracy. FIG. 7 and FIG. 1A together show how this conceptual framework maps to coordinated operation of multiple interconnected models.

Element 700 represents an upper performance envelope within the transportation-safety domain as bounded by the information available from the data model 131 and the transformation model 132. Data model 131 aggregates sensor inputs from devices 120 deployed in environment 110. Transformation model 132 standardizes and structures this input for downstream processing, effectively defining the mathematical function depicted by curve 700 in terms of what constitutes transportation-safety intelligence.

Element 701 depicts a broad domain partition (illustrative 75% accuracy) representing baseline performance when classification model 133 operates without its five sequential sub-models. This corresponds to conventional general detection across diverse scenarios without domain-specific narrowing and motivates the specialized pipeline that follows.

Elements 702 and 703 show initial narrowing produced by the five sub-models of classification model 133 working in sequence. Source-validation sub-model 133B.1 evaluates feed validity against hardware specifications and industry standards, admitting high-quality, domain-relevant data. Synthetic-data detection sub-model 133B.2 removes synthetic content to maintain a real-world corpus as a defining feature of ASI. These stages reduce variability and move performance from 701 toward 702 and 703.

Further narrowing from 702 to 703 is provided by the hallucination-detection sub-model 133B.3, which removes content lacking attributable sourcing, and the deduplication sub-model 133B.4, which consolidates duplicates across temporal, spatial, and source dimensions. Deduplication prevents multiple responses to the same incident and avoids skewing downstream counts and metrics, preserving the intended interpretation of curve 700.

Elements 704 and 705 represent significantly narrower partitions achieved by clustering sub-model 133B.5 working with predictive model 134. The clustering sub-model groups deduplicated items using algorithms such as K-means and BFR in an N-dimensional feature space to form coherent event clusters for specific hazard scenarios. Predictive model 134 then generates domain-specific forecasts per cluster, including pre-accident detection with configurable lead times (e.g., 15-minute advance notice for disabled vehicles, 30-second windows for extreme-speed events). Focusing processing on context-specific clusters enables operating points consistent with the 95%+ accuracy shown for 704 and 705.

Elements 706 and 707 demonstrate advanced specificity using optimization model 135 to hot-swap computational resources based on measured hazard frequency and real-time performance. This dynamic allocation sustains compute-intensive narrow partitions within practical budgets. Transformation model 132 supports these partitions by producing vector-flow representations for motion analysis when appearance cues degrade, enabling wrong-way detection via motion-pattern inversion under low-visibility conditions.

Element 708 illustrates approach toward infinitesimal specificity through coordinated operation of recommendation model 136, simulation model 138, and reinforcement-learning model 139. The recommendation model turns forecasts into concrete responses (including time-to-impact and dispatch instructions). The simulation model projects predicted futures and counterfactual outcomes under alternative interventions to prioritize actions. Reinforcement learning 139 closes the loop by ingesting human-validation signals and measured outcomes to recalibrate thresholds, reweight source trust, and promote or demote model subgraphs based on performance.

In some embodiments, two operational controls are provided: Non-serial Interrupt and Override. Non-serial Interrupt allows high-priority processes to interrupt existing processes while concurrent processes continue in modified states. For example, when the hallucination-detection sub-model requires immediate attention, it can interrupt normal flow while the Synthetic-Data sub-model continues in parallel. Override allows a process to assume root-level priority for dynamic resource reallocation; for instance, when the optimization model determines it can process classification data more efficiently than the current 23% CPU allocation, it assumes override authority to restructure the processing hierarchy.

To manage compute for narrow partitions 706-708, inference and annotation are decoupled. Transformation model 132 performs AI inference on downscaled streams while re-projecting detections onto high-resolution video for operator consumption, creating the perception of high-resolution AI processing while controlling resource use. This enables the extreme specificity of partitions 707 and 708 without prohibitive cost.

The plastic reconfiguration in FIG. 1B allows dynamic selection of which partitions from FIG. 7 to deploy based on conditions, hazard types, and performance requirements. The orchestrator can resequence models 130, parallelize subgraphs, or selectively enable stages to balance broad coverage (701-703) against maximum accuracy (706-708) within available compute.

A human-validation framework operates across all partitions with explicit confidence thresholds aligned to the accuracy levels shown in FIG. 7. Detections from partitions 704-708 that meet high-confidence criteria proceed to operational use; detections from partitions 701-703 route to graduated human validation.

Example thresholds: detections ≥95% confidence route directly to emergency-response systems; 80-95% confidence requires external agency validation; 50-80% confidence requires internal validation; <50% confidence remains under development supervision. This tiering allocates human attention efficiently while maintaining safety.

Overall, the progression from 701 to 708 shows how the FIG. 1A models implement progressive domain narrowing: data standardization, source validation, synthetic-content removal, deduplication, clustering, prediction, optimization, recommendation, simulation, and reinforcement learning convert broad, lower-accuracy intelligence into narrow, higher-accuracy, domain-specific intelligence approaching the envelope indicated by curve 700.

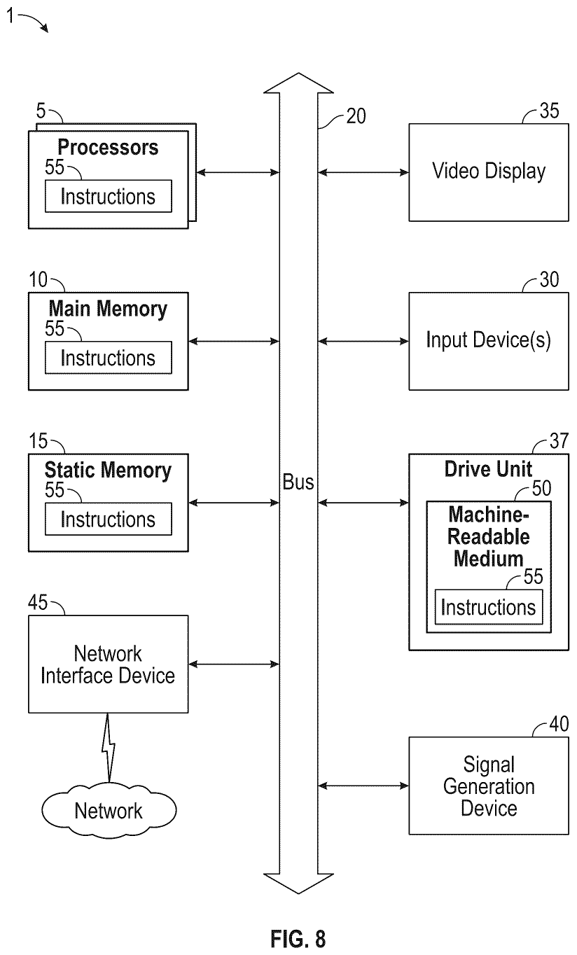

FIG. 8 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. These are considered “endpoints” of a system. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), a neural processing unit (NPU), or any combination thereof), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A multi-model system for generating artificial specific intelligence through domain-partitioned intelligence frameworks, comprising:
a pipeline of interconnected models configured to process data through progressively narrower domain partitions;
a classification model configured to evaluate data through a plurality of sub-models operating in sequence, the sub-models comprising: a source validation sub-model configured to determine validity of data sources within a specific domain, a synthetic hallucination detection sub-model configured to identify and remove synthetic data from validated sources, a deduplication sub-model configured to identify and consolidate duplicate data items, and a clustering sub-model configured to group deduplicated items based on calculated spatial proximity;
a predictive model configured to generate predictions of future events based on classified data from the classification model, wherein the predictions are specific to narrowed domain partitions from the pipeline;
a reinforcement learning model configured to provide feedback to the classification model and the predictive model based on actual outcomes compared to the predictions, wherein the system applies an integral calculus framework that represents intelligence domains as areas under a curve, with the system configured to partition the area into progressively narrower rectangles corresponding to more specific intelligence domains.

2. The system of claim 1, wherein the specific domain is transportation safety, and the predictive model is configured to detect pre-accident scenarios including disabled vehicles, persons or objects in roadways, extreme speeding, or wrong-way drivers with configurable lead times before actual incidents occur.

3. The system of claim 2, further comprising a transformation model configured to perform decoupled inference and annotation by processing AI algorithms on computationally efficient low-resolution data streams while the transformation model re-projects detection results onto high-resolution video outputs.

4. The system of claim 1, wherein the pipeline is plastic and reconfigurable, enabling dynamic resequencing of models, parallelization of model execution, or selective enabling of models based on environmental conditions and performance requirements.

5. The system of claim 1, further comprising a data model configured to gather raw data from a plurality of sensors monitoring an environment in the specific domain, the raw data including real-time data and background data.

6. The system of claim 5, further comprising a transformation model configured to transform the raw data into standardized format data and generate vector flow representations for motion analysis when appearance-based detection becomes unreliable due to lighting conditions.

7. The system of claim 1, further comprising an optimization model configured to implement hot-swapping of computational resources across data sources based on measured hazard frequency and real-time performance metrics.

8. The system of claim 1, further comprising a recommendation model configured to generate actionable recommendations based on the predictions, including dispatch instructions for emergency responders with time-to-impact calculations.

9. The system of claim 1, wherein the predictive model implements a temporal analysis functionality configured to provide advance warning of predicted events and enable intervention during pre-detection phases to prevent predicted outcomes from occurring.

10. The system of claim 1, wherein outputs of the system include a factor providing actionability ratings that prioritize life-threatening situations over property damage, and an expected value providing probability assessments between 0 and 1.0 for predicted outcomes.

11. A method for generating artificial specific intelligence through domain-partitioned intelligence frameworks, comprising:
gathering raw data from a plurality of sensors monitoring an environment in a specific domain using a data model;
transforming the raw data into standardized format data using a transformation model;
classifying the standardized format data using a classification model that applies an integral calculus framework to partition the standardized format data into progressively narrower domain partitions, wherein the classification model includes a sequence of sub-models comprising a source validation sub-model to determine data source validity, a synthetic hallucination detection sub-model to identify and remove synthetic data, a deduplication sub-model to consolidate duplicate data items, and a clustering sub-model to group deduplicated items based on calculated spatial proximity;
generating predictions of future events based on classified data from the classification model using a predictive model, wherein the predictions are specific to the narrowed domain partitions; and
providing feedback to the classification model and the predictive model based on actual outcomes compared to the predictions using a reinforcement learning model.

12. The method of claim 11, wherein the specific domain is transportation safety, and the predictive model generates predictions including pre-accident scenarios such as disabled vehicles, persons or objects in roadways, extreme speeding, or wrong-way drivers with measurable lead times before incidents occur.

13. The method of claim 12, wherein the transformation model applies decoupled inference and annotation processing by running AI algorithms on downscaled video streams while re-projecting detection overlays onto native high-resolution displays.

14. The method of claim 11, further comprising dynamically reconfiguring a pipeline by resequencing models, parallelizing execution, or selectively enabling models based on performance optimization targets and environmental conditions.

15. The method of claim 11, further comprising generating actionable recommendations based on the predictions using a recommendation model, including time-sensitive instructions for emergency response coordination with calculated time-to-impact warnings.

16. A method for generating artificial specific intelligence in a transportation safety domain to detect and prevent hazards, comprising:
collecting real-time data and background data from sensors monitoring a transportation environment using a data model;
processing the collected data into a standardized format using a transformation model to produce processed data;
analyzing the processed data using a classification model that applies an integral calculus framework to partition the transportation safety domain into narrower segments for enhanced accuracy, wherein the analyzing includes validating data sources, detecting synthetic data, removing hallucinations, deduplicating data, and clustering related data items to produce analyzed data;
predicting potential pre-accident scenarios using a predictive model, including disabled vehicles, extreme speeding, or wrong-way drivers based on the analyzed data with configurable advance warning periods; and
generating time-sensitive recommendations using a recommendation model to prevent or mitigate predicted hazards through early intervention based on the potential pre-accident scenarios.

17. The method of claim 16, wherein the transformation model applies vector flow analysis to convert visual scenes into directional motion representations, enabling hazard detection through motion pattern analysis when lighting conditions prevent appearance-based classification.

18. The method of claim 16, further comprising implementing hot-swapping of computational resources using an optimization model by dynamically reallocating processing power across data sources based on measured hazard frequency and changing environmental conditions.

19. The method of claim 16, wherein outputs include a factor for prioritizing actions based on severity and frequency, and an expected value providing probability assessments between 0 and 1.0 for predicted outcomes.

20. The method of claim 16, further comprising implementing human validation through the reinforcement learning model with explicit confidence thresholds where predictions above 95% confidence proceed to operational use, 80-95% confidence requires external human validation, and 50-80% confidence requires internal validation.
